(19) United States
(12) Patent Application Publication
(10) Pub. No.: US 2006/0164750 A1
(43) Pub. Date: Jul. 27, 2006

(54) Magnetic recording and reproducing apparatus

(75) Inventors: Masahiro Negita, Aichi (JP); Sunao Kushiro, Chiba (JP); Shunya Sawada, Aichi (JP); Kentaro Shingai, Tokyo (JP); Satoshi Moriyama, Aichi (JP); Takanobu Sugiyama, Aichi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Shinagawa-Ku (JP)

(21) Appl. No.: 11/319,469

(22) Filed: Dec. 29, 2005

(30) Foreign Application Priority Data
Jan. 25, 2005 (JP) 2005-017274

(51) Int. Cl. G11B 5/027

(52) U.S. Cl. 360/85

(57) ABSTRACT

In a magnetic recording and reproducing apparatus according to the related art, since positions of central points of radiuses of curvature of opposing arc portions of a guide groove are coincident with each other in the direction in which a movable chassis is moved, it is difficult to make the whole of the magnetic recording and reproducing apparatus become light in weight and small in size. A magnetic recording and reproducing apparatus includes a fixed chassis (24) to which a rotary head drum (25) is attached, a movable chassis (23) slidably supported to the fixed chassis (24), a cam gear (51) rotatably supported to the fixed chassis (24) or the movable chassis (23) and which has a cam pin (51a) and a cam plate (59) attached to the movable chassis (23) or the fixed chassis (24) and which has a guide groove (65) with which the cam pin (51a) is slidably engaged, wherein the cam pin (51a) is moved along the guide groove (65) as the cam gear (51) is rotated, whereby rotation operation of the cam pin (51a) is transformed into slide operation of the movable chassis (23) to make the movable chassis (23) come close to or come away the rotary head drum (25). The guide groove (65) includes an arc-like eject side slide portion (66) which is dented in the opposite side of the rotary head drum (25), an arc-like play side slide portion (67) which is dented in the side of the rotary head drum (25) and a slide portion (68) continued to one side of the eject side slide portion (66) and the play side slide portion (67) and which is extended in the direction substantially perpendicular to the direction in which the movable chassis (23) is moved, positions of central points of radiuses of curvature of the eject side slide portion (66) and the play side slide portion (67) being displaced in the direction perpendicular to the direction in which the movable chassis (23) is moved.

### CROSS REFERENCES TO RELATED APPLICATIONS

The present invention contains subject matter related to Japanese Patent Application JP 2005-017274 filed in the Japanese Patent Office on Jan. 25, 2005, the entire contents of which being incorporated herein by reference.

### BACKGROUND OF THE INVENTION

1. Field of the Invention

The present invention relates to a magnetic recording and reproducing apparatus in which a tape cassette having a magnetic tape accommodated therein is attached to a movable chassis, the movable chassis being slid to convey the tape cassette between the play side of a rotary head drum side and the eject position of the opposite side.

2. Description of the Related Art

Cited Patent Reference 1, for example, has described a magnetic recording and reproducing apparatus of this kind according to the related art. That is, the Cited Patent Reference 1 has described an apparatus concerning a recording or reproducing apparatus such as a video tape recorder (VTR). The recording or reproducing apparatus described in this Cited Patent Reference 1 is a recording or reproducing apparatus in which a slide chassis supported to a main chassis so that it can be slid by a predetermined stroke and a slide arm rotated on the above-described main chassis are joined in the oblong groove formed on the slide chassis by a joint pin, the slide chassis being slid by the slide arm. The amount in which the joint pin is moved is set to be slightly overhung from the slide stroke of the slide chassis. At the same time, the surrounding portion of the oblong groove with which the joint pin is engaged is molded by resin, a recess portion is disposed adjacent near the end portion side of the oblong groove corresponding to the slide stroke end of the slide chassis and the end portion of the oblong groove is deformed toward the side of the recess portion by contact with the joint pin to thereby absorb the overhang amount of the joint pin.

According to the recording or reproducing apparatus having the above arrangement, in this kind of recording or reproducing apparatus, there can be expected effects in which shaking or wobbling occurred between a main chassis and a slide chassis can be prevented reliably when a tape cassette is loaded onto this recording or reproducing apparatus and when information is recorded and reproduced while a cost can be prevented from being increased by the increase of the number of assemblies.

Also, Cited Patent Reference 1, for example, has described other magnetic recording and reproducing apparatus according to the related art. The Cited Patent Reference 2 has described a magnetic recording and reproducing apparatus concerning a magnetic recording and reproducing apparatus in which a tape cassette is moved near a rotary head drum by a linear skate chassis to thereby execute tape loading. The magnetic recording and reproducing apparatus described in this Cited Patent Reference 2 is characterized in that a magnetic recording and reproducing apparatus in which tape loading to draw a magnetic tape from a tape cassette mounted on a linear skate chassis by a tape guide block so that the magnetic tape is wound around a rotary head drum is carried out, data being recorded on or reproduced from the magnetic tape. This magnetic recording and reproducing apparatus include a drive mechanism for moving the linear skate chassis or the tape guide block to the predetermined direction relative to the base chassis on which the rotary head drum is fixed in which the tape guide block is moved so as to urge the magnetic tape against the rotary head drum as the linear skate chassis is moved in the direction in which it approaches the rotary head drum by the drive mechanism and a reaction force adjustment mechanism for preventing reaction force of force to move the tape guide block from acting on the direction in which the linear skate chassis is moved in the direction in which it comes away from the rotary head drum.

According to the magnetic recording and reproducing apparatus having the above-mentioned arrangement, since influences exerted by the reaction force of the force to move the tape guide block, the reaction force acting on the linear skate chassis so that the linear skate chassis is moved in the direction in which it comes away from the rotary head drum can be removed, there can be expected effects in which it becomes possible to apply a small motor with low torque to the drive mechanism.

However, in the recording or reproducing apparatus described in the above-mentioned Cited Patent Reference 1, the cam gear and the slide arm are respectively rotatably supported on the main chassis, one pin provided on the slide arm is engaged with and joined to the cam groove of the cam gear and the other pin is engaged with the oblong groove formed on the slide chassis so as to become slidable. Thus, when the cam gear is rotated in the clockwise direction, one pin of the slide arm is moved along the cam groove of the cam gear to rotate the slide arm in the counter-clockwise direction and this rotation causes the other pin to press the oblong groove of the slide chassis to thereby slide the slide chassis. However, the slide arm to slide this slide chassis weighs to a certain extent to increase the weight and thickness of the magnetic recording and reproducing apparatus. There is a problem in which the above slide arm hinders the whole of the magnetic recording and reproducing apparatus from being made small in size and light in weight.

Further, in the case of the magnetic recording and reproducing apparatus described in the Cited Patent Reference 2, a linear skate cam plate having a cam hole is fixed to the bottom portion of the linear skate chassis by a suitable means such as screws and the cam hole of this linear skate cam plate and the guide pin provided on a drive gear are engaged with each other. Thus, when the drive gear is rotated, the guide pin of the drive gear drives the linear skate plate in the horizontal direction to move a linear skate chassis fixed to this linear skate cam plate in the horizontal direction.

In the cam plate of this linear skate cam plate, positions of central points of radiuses of curvature of respective opposing arc portions are coincident with each other in the direction perpendicular to the direction in which the linear skate chassis is moved. As a result, the cam hole is increased in thickness in the direction in which the linear skate chassis is moved, that is, in the width direction of the cam hole and concurrently therewith, the cam plate has to be increased in thickness in the width direction. Thus, it is unavoidable that the weight of the magnetic recording and reproducing apparatus is increased and that a permissible range of the width direction of the cam hole relative to the guide pin is widened with the result that shaking tends to easily occur between the linear skate chassis and the base chassis.

Cited Patent Reference 1: Official Gazette of Japanese laid-open patent application No. 9-97468

Cited Patent Reference 2: Official Gazette of Japanese laid-open patent application No. 2001-351287

The problems encountered with the related-art magnetic recording and reproducing apparatus and which should be solved in the present invention are as follows: That is, since the slide arm that slides the movable chassis has considerable weight and thickness, it is difficult to make the magnetic recording and reproducing apparatus become light in weight and small in size. Further, when the guide pin is engaged with the cam hole in which the positions of the central points of the radiuses of curvature of the opposing arc portions are coincident with each other in the direction perpendicular to the direction in which the movable chassis is moved to thereby slide the movable chassis, since the cam hole is increased in thickness in the width direction so that the cam plate should be made large in size, shaking tends to easily occur between the linear skate chassis and the base chassis. Furthermore, it is unavoidable that the magnetic recording and reproducing apparatus is increased in weight.

### SUMMARY OF THE INVENTION

In view of the aforesaid aspects, the present invention intends to provide a magnetic recording and reproducing apparatus in which shaking can be prevented from occurring between a linear skate chassis and a base chassis.

The present invention intends to provide a magnetic recording and reproducing apparatus in which the occurrence of shaking between the linear skate chassis and the base chassis can be suppressed.

Further, the present invention intends to provide a magnetic recording and reproducing apparatus of which cam mechanism can be adjusted with ease.

Furthermore, the present invention intends to provide a magnetic recording and reproducing apparatus in which a movable chassis can be moved quickly.

According to an aspect of the present invention, there is provided a magnetic recording and reproducing apparatus which is comprised of a fixed chassis to which a rotary head drum is attached, a movable chassis slidably supported to the fixed chassis, a cam gear rotatably supported to the fixed chassis or the movable chassis and which has a cam pin and a cam plate attached to the movable chassis or the fixed chassis and which has a guide groove with which the cam pin is slidably engaged, wherein the cam pin is moved along the guide groove as the cam gear is rotated, whereby rotation operation of the cam pin is transformed into slide operation of the movable chassis to make the movable chassis come close to or come away from the rotary head drum. In the magnetic recording and reproducing apparatus, the guide groove includes an arc-like eject side slide portion which is dented in the opposite side of the rotary head drum, an arc-like play side slide portion which is dented in the side of the rotary head drum and a slide portion continued to one side of the eject side slide portion and the play side slide portion and which is extended in the direction substantially perpendicular to the direction in which the movable chassis is moved, positions of central points of radiuses of curvature of the eject side slide portion and the play side slide portion being displaced in the direction perpendicular to the direction in which the movable chassis is moved.

In the magnetic recording and reproducing apparatus according to the present invention, the cam plate is supported to the movable chassis or the fixed chassis such that it can be rotated about a supporting point shaft of the movable chassis or the fixed chassis.

Further, in the magnetic recording and reproducing apparatus according to the present invention, the eject side slide portion and the play side slide portion of the slide portion have a protruded portion protruded toward the side of the play side slide portion.

According to the magnetic recording and reproducing apparatus of the present invention, since the positions of the central points of the radiuses of curvature of the eject side slide portion and the play side slide portion of the guide groove formed on the cam plate are displaced in the direction perpendicular to the direction in which the movable chassis is moved, while maintaining a desired stroke (amount in which the movable chassis is moved), a space in the width direction of the guide groove can be narrowed and the cam plate can be made small in size. Thus, the whole of the apparatus can be made light in weight and small in size. Also, since the space in the width direction of the guide groove is narrowed, it is possible to prevent shaking from occurring between the linear skate chassis and the base chassis or it is possible to suppress the occurrence of shaking between the linear skate chassis and the base chassis.

According to the magnetic recording and reproducing apparatus of the present invention, since the cam plate is supported to the movable chassis or the fixed chassis so that it can rotate about the supporting point shaft provided on the movable chassis or the fixed chassis, the cam plate can be adjusted extremely easily so as to absorb dimension error of respective assemblies and error of attachment accuracy of assemblies. Therefore, it is possible to provide a cam mechanism of which adjustment work is easy.

Further, according to the magnetic recording and reproducing apparatus of the present invention, since the slide portion is formed at the position retreated one step by the protruded portion after the cam pin passed the eject side slide portion, the movable chassis can be moved earlier by the amount corresponding to the protruded amount of the protruded portion, thereby making it possible to rapidly move the movable chassis.

### BRIEF DESCRIPTION OF THE DRAWINGS

FIG. 1 is a perspective view showing a magnetic recording and reproducing apparatus according to an embodiment of the present invention and showing from the back side the state in which a tape cassette is loaded onto a cassette holder;

FIG. 2 is an explanatory diagram showing the magnetic recording and reproducing apparatus according to the embodiment of the present invention and showing from the top side the state in which a movable chassis is detached from a rotary head drum;

FIG. 3 is an explanatory diagram to which reference will be made in explaining the eject state of the magnetic recording and reproducing apparatus shown in FIG. 1;

FIG. 4 is an explanatory diagram to which reference will be made in explaining the state in which the cassette holder of the magnetic recording and reproducing apparatus shown in FIG. 1 can be moved to the lower portion position;

FIG. 5 is an explanatory diagram to which reference will be made in explaining somewhere of the state in which the movable chassis of the magnetic recording and reproducing apparatus shown in FIG. 1 is being moved to the rotary head drum side;

FIG. 6 is an explanatory diagram to which reference will be made in explaining the state in which the movable chassis of the magnetic recording and reproducing apparatus shown in FIG. 1 is moved to the tape loading position so that the magnetic recording and reproducing apparatus is placed in the stop mode;

FIG. 7 is an explanatory diagram to which reference will be made in explaining the state in which the movable chassis of the magnetic recording and reproducing apparatus shown in FIG. 1 is moved to the tape loading position so that the magnetic recording and reproducing apparatus is placed in the play mode;

FIG. 8 is an explanatory diagram to which reference will be made in explaining a cam plate of the magnetic recording and reproducing apparatus shown in FIG. 1; and

FIGS. 9A and 9B are respectively explanatory diagrams to which reference will be made in explaining a positional relationship between a guide groove and a cam pin and moving operations of the movable chassis of the magnetic recording and reproducing apparatus shown in FIG. 1.

### DESCRIPTION OF THE PREFERRED EMBODIMENTS

The present invention will now be described in detail with reference to the accompanying drawings. Prior to the description of the embodiments of the present invention, a magnetic recording and reproducing apparatus according to the embodiments of the present invention will be outlined as follows. That is, since a slide arm is reduce, a cam pin is provided on a cam gear, a guide groove with which the cam pin is engaged is formed on a plate, the cam pin is slid along the guide groove as the cam gear is rotated to thereby slide a movable chassis, positions of central points of radiuses of curvature of an eject side slide portion and a play side slide portion of the guide groove are displaced in the direction perpendicular to the direction in which the movable chassis is moved and the cam groove and the cam plate are made compact in size, it is possible to realize by a simple structure a magnetic recording and reproducing apparatus in which the whole of the apparatus can be made light in weight and small in size.

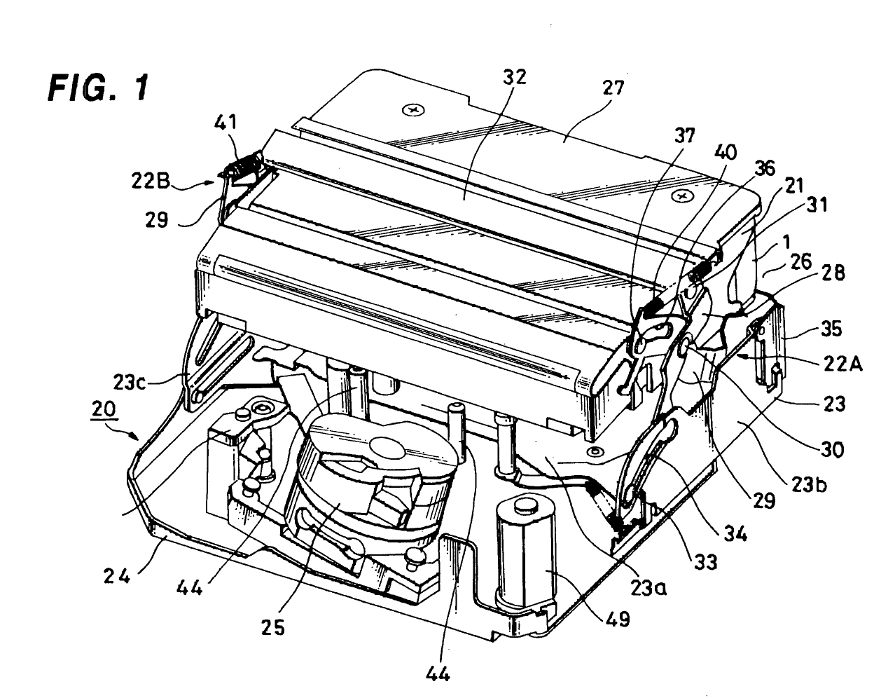

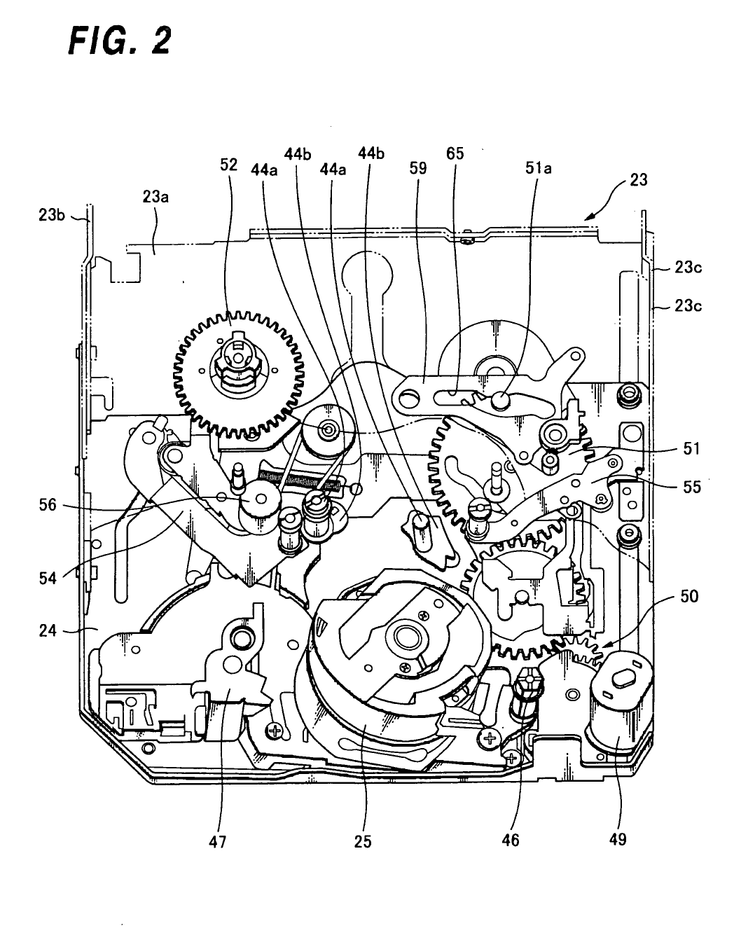

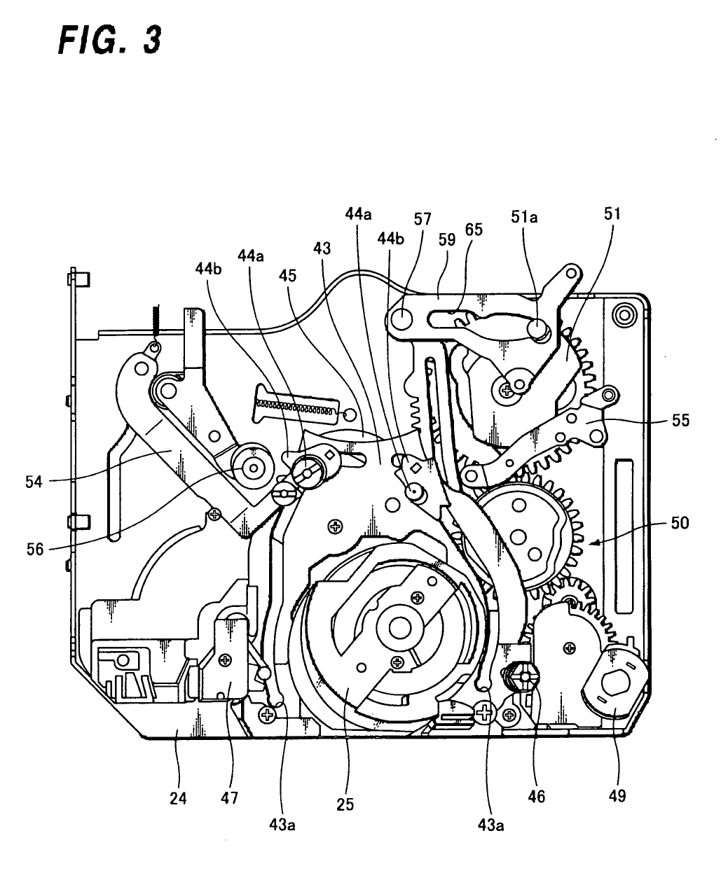

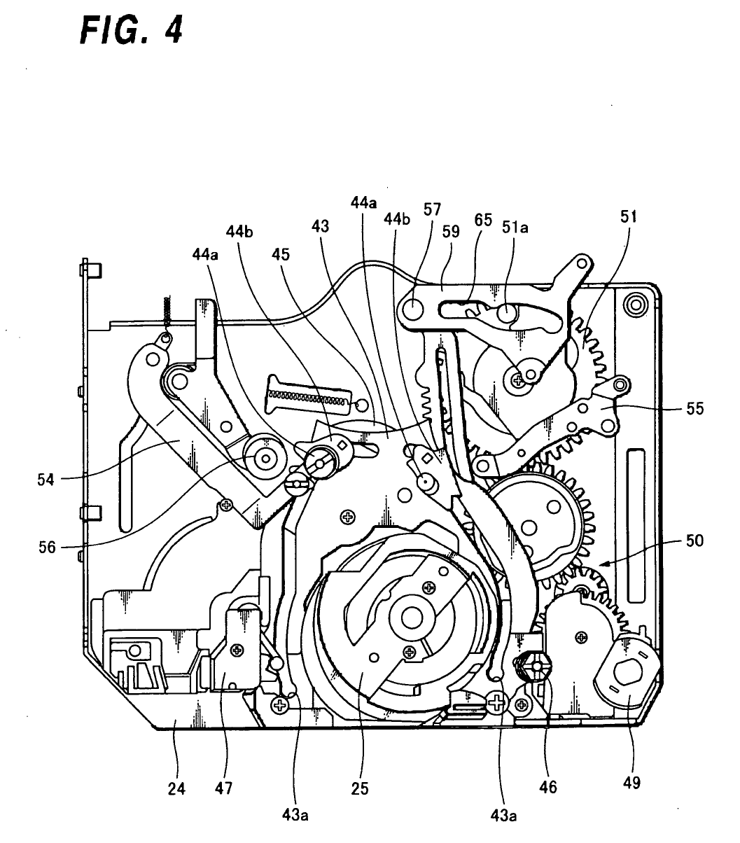

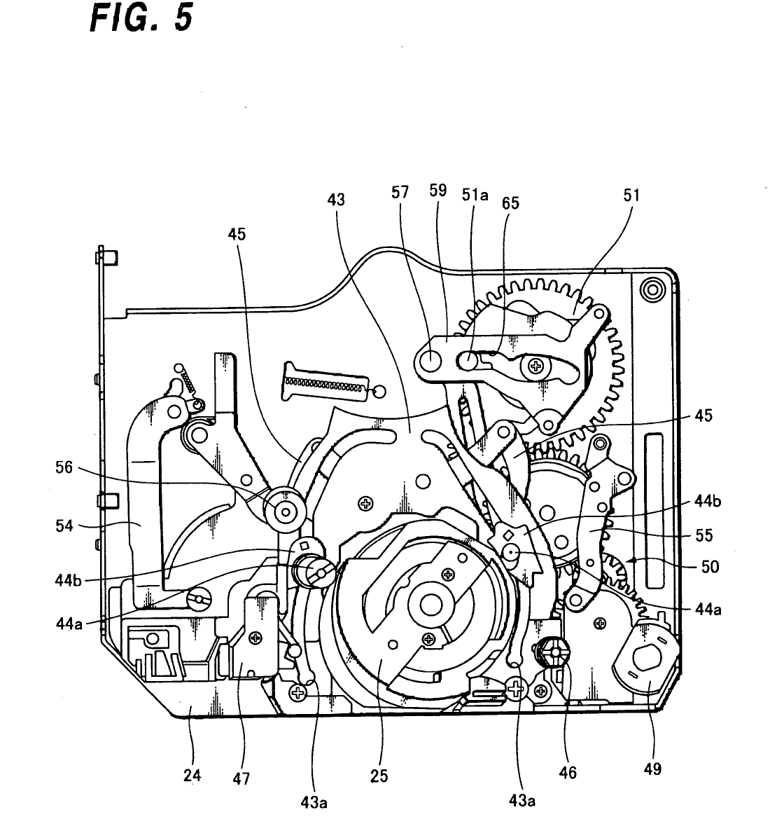

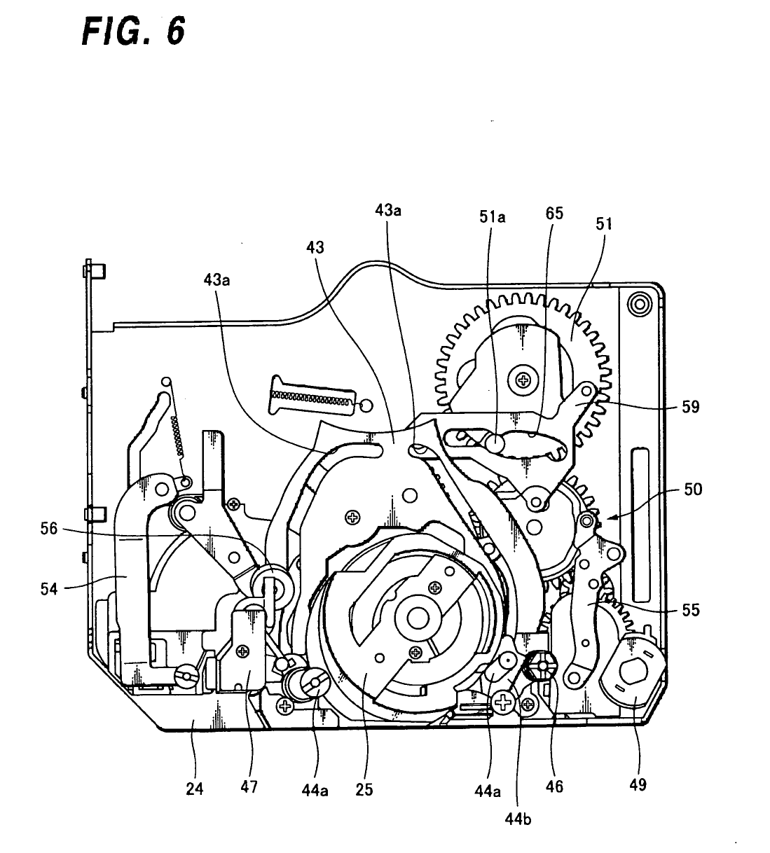

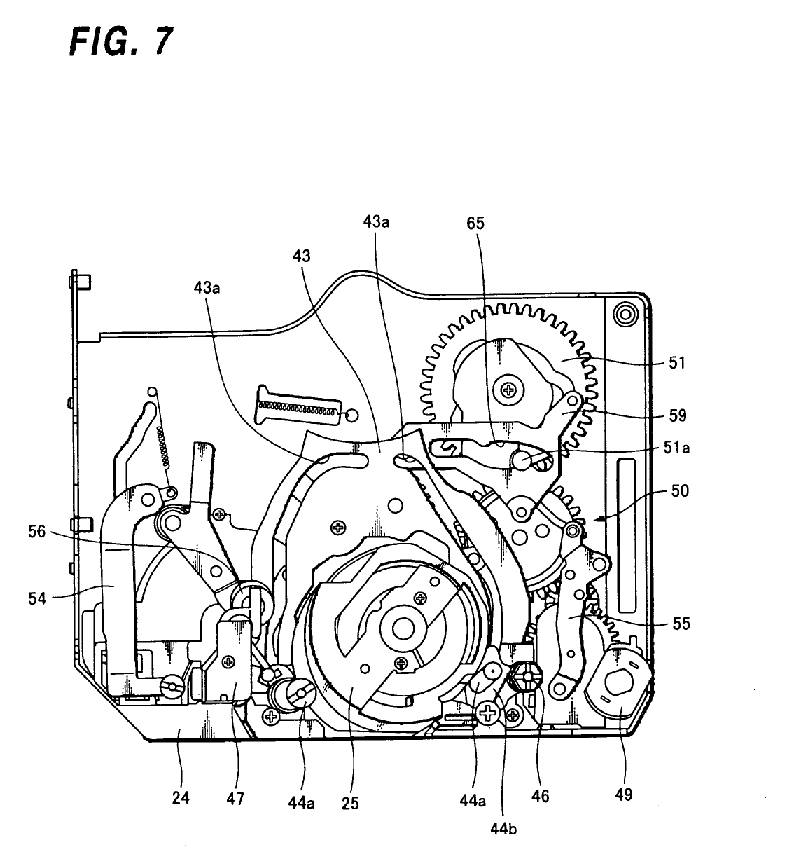

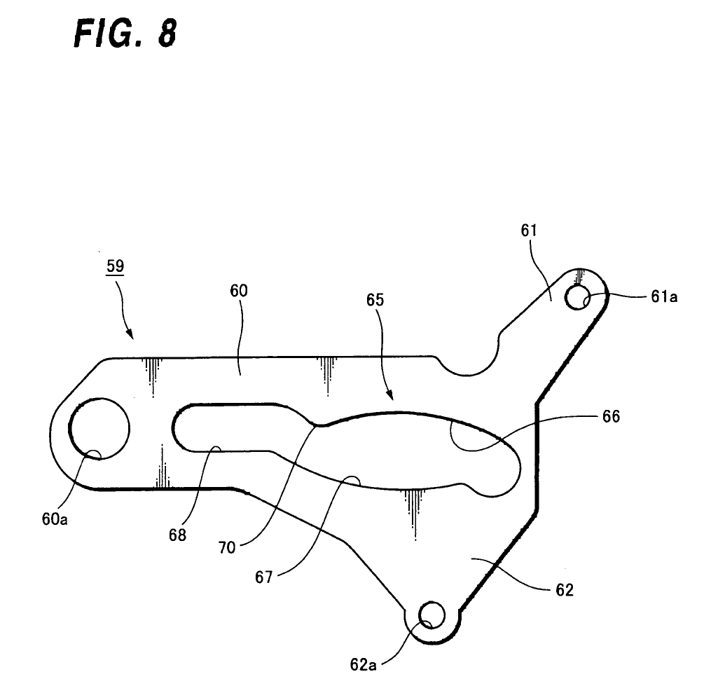

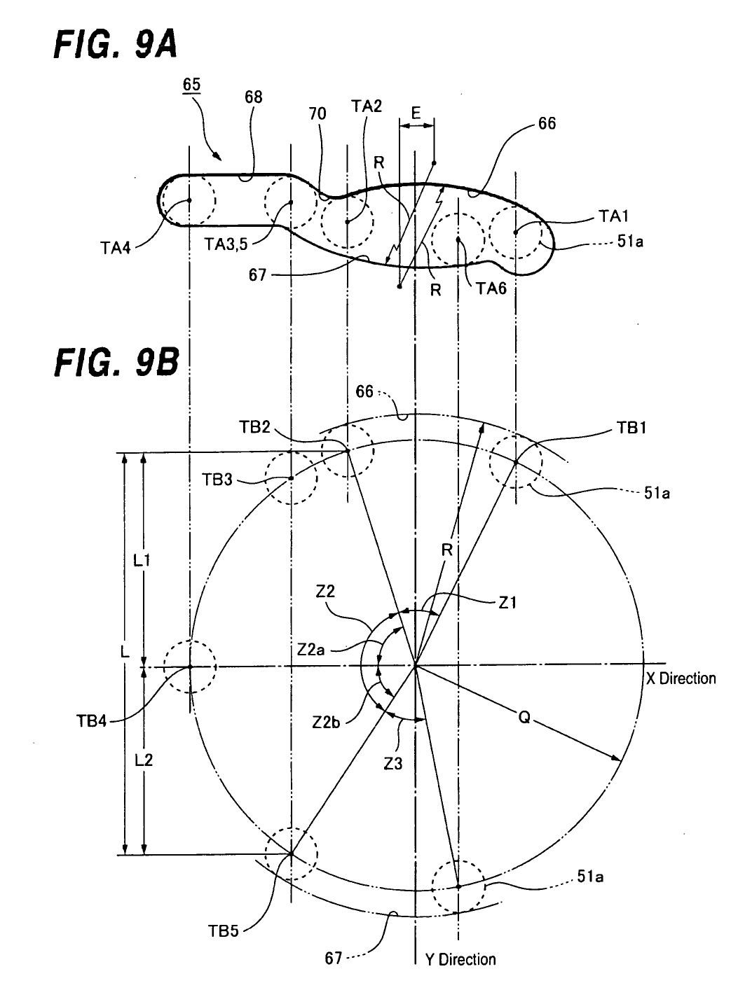

FIG. 1 to FIGS. 9A and 9B of the accompanying drawings are diagrams showing a magnetic recording and reproducing apparatus according to the embodiments of the present invention. Specifically, FIG. 1 is a perspective view showing a magnetic recording and reproducing apparatus according to the present invention. FIG. 2 is a perspective view showing from the top side the state in which a cassette holder is placed at the upper portion position (position at which a cassette compartment is elevated). FIGS. 3 to 7 are explanatory diagrams to which reference will be made in explaining relationships between the engagement state of a guide groove and a cam pin and the states of the magnetic recording and reproducing apparatus wherein FIG. 3 shows the state in which a tape cassette is ejected from the magnetic recording and reproducing apparatus; FIG. 4 shows the state in which a cassette holder with the tape cassette loaded thereon can be moved to the lower portion position (position at which the cassette compartment is lowered); FIG. 5 shows somewhere of the state in which the movable chassis is being moved to the rotary head drum side; FIG. 6 shows the state in which the movable chassis is moved to the tape loading position so that the magnetic recording and reproducing apparatus is placed in the stop mode; FIG. 7 shows the state in which the movable chassis is moved to the tape loading position so that the magnetic recording apparatus is placed in the play mode; FIG. 8 is an explanatory diagram showing a cam plate in an enlarged-scale; and FIGS. 9A and 9B are respectively explanatory diagrams used to explain the manner in which the movable chassis is moved as a guide groove and a cam pin are being engaged with each other.

As shown in FIG. 1, a magnetic recording and reproducing apparatus 20 according to this embodiment is composed of a cassette holder 21 on which a tape cassette 1 is detachably attached, a holder supporting means consisting of a pair of link members 22A and 22B to support both sides of the cassette holder 21 so that the cassette holder 21 can be moved freely, a movable chassis 23 to support the pair of link members 22A and 22B so that the pair of link members 22A and 22B can be changed in attitude, a fixed chassis 24 to support the movable chassis 23 so that the movable chassis 23 can be moved freely, a rotary head drum 25 on which a magnetic head is provided, a control apparatus to control movement of the movable chassis 23, driving of the rotary head drum 25 and the like.

The cassette holder 21 is constructed by a square case that can surround the tape cassette 1 with four surface portions. Specifically, the cassette holder 21 includes an upper surface portion opposed to the upper surface of the tape cassette 1, a lower surface portion supporting the inserted tape cassette 1 and a left side surface portion and a right side surface portion continued from both right and left sides of the upper surface portion so as to oppose to the left and right side surfaces of the tape cassette 1. Of two opening portions opened in the directions perpendicular to these four surfaces, one opening portion is formed as a cassette loading and unloading slot 26 into and from which the tape cassette 1 is loaded and unloaded and the other opening portion is opposed to the rotary head drum 25.

A panel 27, made of engineering plastic in order to decrease a weight of the cassette holder 21, is fixed to the upper surface portion of the cassette holder 21 by suitable fixing means such as fixed screws. This panel 27 may make the cassette holder 21 become attractive as well as it may serve as a reinforcing material to increase strength of the upper surface portion of the cassette holder 21. The lower surface portion of the cassette holder 21 is used to support the lower surface of the tape cassette 1 and therefore it is formed as a U-like frame member that can support three sides of the tape cassette 1. Also, the left and right side surface portions of the cassette holder 21 are formed of plate members that have substantially the same thickness and height as those of the tape cassette 1. The pair of link members 22A and 22B may be disposed at the outsides of these side surface portions.

The pair of link members 22A and 22B is composed of first and second links 28 and 29 crossing to each other and a rotary shaft portion 30 provided at the crossing portion so that the pair of link members 22A and 22B are joined together so as to become freely rotatable. The rotary shaft portion 30 consists of a cylindrical projected portion formed on one link and a through-hole formed on the other link and it can be completed by caulking the tip end portion of the cylindrical projected portion after the cylindrical projected portion was inserted through the through-hole. The first link member 22A is disposed outside the left side surface portion of the cassette holder 21 and the second link member 22B is disposed outside the right side surface portion of the cassette holder 21.

The upper portions of the first link 28 of the pair of link members 22A and 22B are respectively supported to substantially central portions of the upper portions of the respective side surface portions of the cassette holder 21 by a rotary shaft 31 so as to become freely rotatable. Further, the two first links 28 and 28 are joined together as one body by a joint member 32. Guide pins 33 are respectively provided on the lower portions of the two first links 28 and 28 so as to project to the outside opposite to the cassette holder 21. The respective guide pins 33 and 33 are slidably engaged with guide holes 34 and 34 bored on the movable chassis 23. The respective guide holes 34 are decreased in thickness in the opposite side of the cassette insertion slot 26 in such a manner that the first links 28 and 28 are progressively moved in the lower direction as the inclinations of the first links 28 and 28 are increased.

Also, the lower portions of the pair of second links 29 and 29 are extended to the lower direction of the cassette insertion slot 26 of the cassette holder 21 so that they may be joined to a frame plate 35 by a rotary shaft portion so as to become freely rotatable. The frame plate 35 is fixed to the chassis 33 by screws and the lower portions of the second links 29 and 29 are rotatably supported through this frame plate 35 to the movable chassis 23, respectively.

Guide holes 36 and 36, which are extended in the directions in which the pair of second links 29 and 29 are extended, are respectively formed on the upper portions of the pair of second links 29 and 29. The respective guide holes 36 and 36 are formed of arc-like oblong holes of which upper sides are protruded and guide pins 37 and 37 formed on the respective side surface portions of the cassette holder 21 are slidably engaged into the guide holes 36 and 36, respectively. The respective guide pins 37 and 37 are disposed on the upper portions of the opposite side of the cassette insertion slot 26 on the respective side surface portions of the cassette holder 21. Further, the second links 29 and 29 have spring receiving pieces formed on their upper portions, respectively.

One end of a first coil spring 40 formed of a tension spring is engaged with the spring receiving member of one of the second links 29 and 29. Also, one end of a second coil spring 41 formed of a tension spring is engaged with the spring receiving piece of the other of the second links 29 and 29. The other end of the first coil spring 40 is engaged with a spring receiving portion provided on the left side surface portion of the cassette holder 21 under tension. The other end of the second coil spring 41 is engaged with a spring receiving portion interposed between the second link portion 22B and the cassette holder 21 under tension.

The lock arm is adapted to lock and hold the cassette holder 21 in the state in which the cassette holder 21 is lowered and accommodated within the movable chassis 23. This lock arm is rotatably supported to the cassette holder 21 by a rotary shaft. The lock arm has on its lower portion provided a stopper click which is engaged with the movable chassis 23 in the state in which the cassette holder 21 is accommodated within the movable chassis 23. The lock arm has on its upper portion provided a spring receiving portion and the lock arm is biased on the side of the cassette insertion slot 26 under spring force of the second coil spring 41 whose one end is engaged with the spring receiving portion.

As shown in FIGS. 2 to 7, the chassis 24 is formed of substantially a square plate member and has the rotary head drum 25 attached to substantially a central portion of its back side. The rotary head drum 25 includes a fixed portion to which the fixed chassis 24 is fixed and a rotary portion to which the fixed portion is rotatably supported, and a magnetic head is attached to its rotary portion. This rotary head drum 25 is attached to the rotary portion with its rotation central line being skewed slightly.

A guide rail 43 is disposed on the fixed chassis 24 so as to surround the rotary head drum 25. The guide rail 43 is formed of a plate member made of resin and it includes rail grooves 43a and 43a provided from the front portion to the side portion of the rotary head drum 25. The rail grooves 43a and 43a of the guide rail 43 have a pair of tape guides 44 and 44 by which a magnetic tape is drawn from the tape cassette 1 and wrapped around the peripheral surface of the rotary head drum 25.

The tape guides 44 and 44 include guide pins 44a and 44a to draw the magnetic tape and tape guide blocks 44b, 44b which are engaged with the rail grooves 43a and 43a of the guide rail 43. The tape guide blocks 44b and 44b have on their lower surfaces provided a convex portion which penetrates the rail grooves 43a and 43a, and this convex portion is joined to a tape guide moving mechanism. Thus, the pair of tape guides 44 and 44 can be moved back and forth along the rail grooves 43a and 43a. As a consequence, the magnetic recording and reproducing apparatus is able to execute tape loading in which the magnetic tape is drawn from the magnetic tape and wrapped around the rotary head drum 25 and tape unloading in which the magnetic tape is returned into the tape cassette 1 by releasing the winding of the magnetic tape from the rotary head drum 25.

The tape guide moving mechanism includes a tape guide gear (not shown) rotatably supported to the fixed chassis 24, a pair of tape guide arms 45 and 45 to move the tape guides 44 and 44 back and forth as the tape guide gear is rotated and the like. The tape guide gear is engaged with a slider ring 58, which will be described later on, supported to the movable chassis 23. This slider ring 58 is slid to rotate the tape guide gear as the movable chassis 23 is slid.

Also, a fixed tape guide 46, which is one of tape guides to load the magnetic tape, and a capstan 47 to transport the magnetic tape at a constant speed are provided near the rotary head drum 25 of the fixed chassis 24. The capstan 47 serves as a rotary shaft of a step motor (not shown) as well and as the capstan 47 is rotated, the magnetic tape is transported at a predetermined speed. Further, the fixed chassis 24 is provided with a drive motor 49, a gear train 50 formed of a combination of a plurality of gears rotated by the drive motor 49, a cam gear 51 rotated by the gear train 50 and the like. The cam gear 51 has on its upper surface provided a cam pin 51a engaged with a guide groove 65 of a cam plate 59, which will be described later on, to which the movable chassis 23 is attached.

The movable chassis 23 is composed of a bottom surface portion 23a and side surface portions 23b and 23c continued to both left and right directions of the bottom surface portion 23a. The guide holes 34 are formed on the left and right side surface portions 23b and 23c of the movable chassis 23. A take-up reel 52 and a supply reel (not shown) are rotatably attached to the upper surface of the bottom surface portion 23a of the movable chassis 23 with a predetermined space therebetween. A left tension guide 54 and a right tension guide 55 for applying predetermined tension to the magnetic tape drawn from the tape cassette 1 and a pinch roller 56 for urging the magnetic tape against the capstan 47 provided on the fixed chassis 24 are provided on the upper surface of the bottom surface portion 5a.

A slider link 58 and a cam plate 59 are rotatably supported to the lower surface of the bottom surface portion 23a of the movable chassis 23 by a supporting point pin 57. The slider link 58 is formed of a long and narrow plate member and it includes a slide guide groove 58a provided at the central portion of the width direction and a rack portion 58b provided on one side of the longitudinal direction. The rack portion 58b of the slider link 58 is engaged with the tape guide gear of the tape guide moving mechanism and the slide guide groove 58a is engaged with a convex portion (not shown) provided on the fixed chassis 24.

The cam plate 59 is composed of a main body portion 60 of substantially rectangular flat plate shape, a first fixed portion 61 continuously formed from one corner portion of this main body portion 60 and a second fixed portion 62 continuously formed from one side of the longitudinal direction of the main body portion 60 as shown in FIG. 8.

First and second tapped holes 61a and 62a are formed on the tip ends of the first and second fixed portions 61 and 62 of the cam plate 59. The two tapped holes 61a and 62a may adjust the cam plate 59 rotating about the supporting point pin 57 at so proper positions as to absorb dimension error of respective assemblies and error of attachment accuracy of assemblies and the like and they may fix the cam plate 59 at those positions. A through-hole 60a through which the supporting point pin 57 is penetrated is formed on the main body portion 60 at its side opposite to the first and second fixed portions 61 and 62 and a guide groove 65 which is engaged with the cam pin 51a of the cam gear 51 is provided at substantially the central portion of the main body portion 60.

As shown in FIGS. 8 and 9A, the guide groove 65 is formed of a cam groove in which a plurality of concave and convex curved line portions has one ring-like edge portion continuously and it includes an eject side slide portion (range from a point TA1 to a point TA2) 66, a play side slide portion (range from a point TA5 to a point TA6) 67 opposed to the eject side slid portion 66 and a slide portion (range from the point TA2 to a point TA3 and to a point TA5 through a point TA4) 68 continuing to one side of the two slide portions 66 and 67. A protruded portion 70 is provided between the eject side slide portion 66 and the slide portion 68 so as to protrude toward the side of the play side slide portion 67.

As shown in FIG. 9A, the eject side slide portion 66 has a shape substantially identical to an arc with a radius of curvature R drawn by an outer peripheral edge of a rotation locus obtained when the cam pin 51a of the cam gear 51 is rotated. Also, the play side slide portion 67 has a shape substantially identical to an arc with a radius of curvature R which draws the outside of the locus at the portion displaced from the eject side slide portion 66 180°. Central points of the radiuses of curvature R of the eject side slide portion 66 and the play side slide portion 67 are displaced in the X direction substantially perpendicular to the Y direction which is the direction in which the movable chassis 23 is translated as shown in FIG. 9B and a displacement amount is E. Further, since the shapes of the eject side slide portion 66 and the play side slide portion 67 are identical to the rotation locus of the cam pin 51a, the cam pin 51a may run idle during the cam pin 51a is rotated in slidable contact with these slide portions 66 and 67 so that the movable chassis 23 having the cam plate 59 with the guide groove 59 attached thereto can be prevented from being moved.

The slide portion 68 is extended in the direction substantially crossing at a right angle the direction in which the eject side slide portion 66 and the play side slide portion 67 are opposed to each other. The cam pin 51a is moved along the side portion 68, whereby the movable chassis 23 is moved in the above-described opposing direction in which the eject side slide portion 66 and the play side slid portion 67 are opposed to each other, that is, the direction in which the movable chassis 23 comes close to or comes away from the rotary head drum 25. A moving distance L of the cam pin 51a is approximately twice a length Q from the rotation center of the cam gear 51 to the center of the cam pin 51a. As shown in FIGS. 9A and 9B, the slide portion 68 enables the cam pin 51a to move in the outward stroke ranging from a position TA2 through a position TA3 to a position TA4 and in the inward stroke ranging from the position TA4 to a position TA5. As the cam gear 51 is rotated, in the outward stroke, the cam pin 25a is rotated from a position TB2 to a position TB3 first, whereby the cam pin 51a is moved from the position TA2 to the position TA3. Then, as the cam pin 51a is rotated from the position TB3 to a position TB4, the cam pin 51a is moved from the position TA3 to the position TA4 within the slide portion 44. In this manner, the cam pin 51a is moved in the outward stroke, whereby the movable chassis 23 is moved a moving distance L1 and thus the outward stroke is ended.

Next, in the inward stroke, as the cam gear 51 is rotated, the cam pin 51a is rotated from the position TB4 to the position TB5, whereby the cam pin 51a is moved from the position TA4 to the position TA5 within the slide portion 68. In this manner, the cam pin 51a is moved in the inward stroke, whereby the movable chassis 23 is moved a moving distance L2 and the inward stroke is ended. This moving distance L2 is slightly shorter than the moving distance L1 (L2<L1) because the cam pin 51a is not moved from the position TB2 to the position TB3. As a consequence, the movable chassis 23 can move the moving distance L (L=L1+L2) which is the predetermined stroke and thereby tape loading can be carried out.

A control apparatus for controlling driving of the movable chassis 23 and the like is constructed by suitable means such as a microcomputer and a predetermined control system is stored in a storage apparatus in advance. Thus, necessary control can be executed on the magnetic recording and reproducing apparatus 20.

According to the magnetic recording and reproducing apparatus 20 having the above-mentioned arrangement, the movable chassis 23 can slide relative to the fixed chassis 24 as follows, for example. FIG. 3 shows main portions of the movable chassis 23 and the fixed chassis 24 in the state in which the tape cassette 1 is ejected from the magnetic recording and reproducing apparatus 20. At that time, as shown in FIGS. 9A and 9B, the cam pin 51a of the cam gear 51 is located at the position TB1 and it is engaged at the position TA1 of the guide groove 65. In this state, the movable chassis 23 is supported to the fixed chassis 24 at the position in which it is most distant from the rotary head drum 25.

Next, as shown in FIG. 4, the drive motor 49 is rotated under control of the control apparatus (not shown) to rotate the cam gear 51 through the gear train 50. At that time, the cam gear 51 rotates only a previously-set angle Z1 to rotate the cam gear 51a from the position TB1 to the position TB2 as shown in FIG. 9B. In consequence, the cam pin 51a is slid along the eject side slide portion 66 of the guide groove 65 from the position TA1 to the position TA2 as shown in FIG. 9A. At that time, since the shape of the eject side slide portion 66 is identical to the rotation locus of the cam pin 51a, rotation operation of the cam pin 51a cam be prevented from being transformed into slide operation of the movable chassis 23. Accordingly, the movable chassis 23 can be prevented from being moved from the position at which it is most distant from the rotary head drum 25.

Next, the tape cassette 1 is loaded onto the cassette holder 21 and the user moves the cassette holder 21 to the lower portion position (position at which the cassette compartment is placed in the lower direction) by pressing its upper surface portion with a suitable means such as fingers. Thus, when the cassette holder 21 is moved to the lower portion position, the drive motor 49 is driven under control of the control apparatus, not shown, to rotate the cam gear 51 through the gear train 50. FIG. 5 is a diagram showing somewhere of the state in which this cam gear 51 is being rotated, and FIG. 6 is a diagram showing the state in which the cam gear 51 has finished rotating.

Operations of this cam gear 51 will be described in detail below. That is, in somewhere of the state in which the cam gear 51 is being rotated, as shown in FIG. 9B, since the cam gear 51 is rotated an angle Z2a of the previously-set angle Z2, the cam pin 51a is rotated from the position TB2 through the position TB3 to the position TB4, whereby the cam pin 51a is slid from the position TA2 through the position TA3 to the position TA4 along the slide portion 68 of the guide groove 65 as shown in FIG. 9A.

At that time, since the shape of the slide portion 68 is not identical to the rotation locus of the cam pin 51, the rotation operation of the cam pin 51a is transformed into the slide operation of the movable chassis 23, whereby the movable chassis 23 is moved in the direction in which it approaches the rotary head drum 25 and its moving distance becomes L1. Also, when the cam pin 51a is slid from the position TA2 to the position TA3, it passes the protruded portion 46 so that the movable chassis 23 can be moved earlier by a time corresponding to the protruded amount of this protruded portion 46.

Subsequently, since the cam gear 51 is moved with the remaining angle Z2b of the previously-set angle Z2, the cam pin 51a is rotated from the position TB4 to the position TB5, whereby the cam pin 51a is slid from the position TA4 to the position TA5 along the slide portion 68 of the guide groove 65. As described above, the shape of the slide portion 68 is not identical to the rotation locus of the cam pin 51a so that the rotation operation of the cam pin 51a is transformed into the slide operation of the movable chassis 33. In consequence, the movable chassis 23 is translated in the direction in which it may approach the rotary head drum 25 and its moving distance becomes L2.

As described above, the cam pin 51a is slid from the position TA2 through the positions TA3 and TA4 to the position TA5 along the slide portion 68 of the guide groove 65, whereby the movable chassis 23 is moved with the distance L (L1+L2) in the direction in which it is approaching the rotary head drum 25 and hence it comes closest to the rotary head drum 25. This state is the state in which the magnetic tape is wrapped around the rotary head drum 25.

Next, as shown in FIG. 7, under control of the control apparatus (not shown), the drive motor 49 is rotated to rotate the cam gear 51 more through the gear train 50. At that time, as shown in FIG. 9B, the cam gear 51 is rotated only a previously-set angle Z3 to rotate the cam pin 51a from the position TB5 to the position TB6, whereby the cam pin 51a is slid from the position TA5 to the position TA6 along the play side slide portion 67 of the guide groove 65. At that time, since the shape of the play side slide portion 67 is identical to the rotation locus of the cam pin 51a in the same manner as that of the eject side slide portion 66, the rotation operation of the cam pin 51a can be prevented from being transformed into the slide operation of the movable chassis 23. Accordingly, the movable chassis 23 can be prevented from being moved from the position at which it is located most close to the rotary head drum 25.

When the cam pin 51a is moved to the position TB6, the magnetic recording and reproducing apparatus 20 is placed in the play mode so that it becomes able to record information on the magnetic tape in the tape cassette 1 or to reproduce information from the magnetic tape in the tape cassette 1.

The movable chassis 23 can be moved again to the eject position by rotating the drive motor 49 in the reverse direction under control of the control apparatus (not shown). That is, the guide pin 51a is returned from the position TB6 to the position TB1 by reversing the rotation direction of the cam gear 51. As a result, the cam pin 51a is moved from the position TA6 to the position TA5 in an arc-like fashion and the cam pin 51a is moved reciprocally on the slide portion 68 in a straight-line fashion until the cam pin 51a is moved from the position TA5 through the positions TA4 and TA3 to the position TA2. Further, the cam pin 51a is moved in an arc-like fashion from the position TA2 to the position TA1 and it reaches the position TA1. As a consequence, the rotation motion of the drive motor 49 is transformed into the straight-line motion by the cam mechanism consisting of the cam gear 51 and the cam groove 41 to move the movable chassis 23 in the direction in which it may come away from the rotary head drum 25.

According to the present invention, since the magnetic recording and reproducing apparatus 20 has the arrangement in which the supporting point of the slider link 58 and the supporting point of the cam plate 59 are commonly supported by the supporting point pin 57, the number of assemblies can be decreased, work efficiency required upon assembly and disassembly can be improved and hence work efficiency can be improved.

The present invention is not limited to the embodiments which have been described so far with reference to the drawings and it can be variously changed and modified without departing from the gist thereof. For example, while the example of the magnetic recording and reproducing apparatus capable of recording and reproducing information has been described so far, the present invention is not limited thereto and it is needless to say that the present invention can be applied to a magnetic reproducing apparatus exclusively-designed to only reproduce information and a magnetic recording apparatus exclusively-designed only to record information. Further, while the camera apparatus such as the video camera has been described as the electronic device using the magnetic recording and reproducing apparatus according to the present invention, the present invention is not limited thereto and can be applied to a video tape recorder and a cassette tape player using this kind of magnetic recording and reproducing apparatus and various kinds of other electronic devices.

According to the magnetic recording and reproducing apparatus of the present invention, since the positions of the central points of the radiuses of curvature of the eject side slide portion and the play side slide portion of the guide groove formed on the cam plate are displaced in the direction perpendicular to the direction in which the movable chassis is moved, while maintaining a desired stroke (amount in which the movable chassis is moved), a space in the width direction of the guide groove can be narrowed and the cam plate can be made small in size. Thus, the whole of the apparatus can be made light in weight and small in size. Also, since the space in the width direction of the guide groove is narrowed, it is possible to prevent shaking from occurring between the linear skate chassis and the base chassis or it is possible to suppress the occurrence of shaking between the linear skate chassis and the base chassis.

According to the magnetic recording and reproducing apparatus of the present invention, since the cam plate is supported to the movable chassis or the fixed chassis so that it can rotate about the supporting point shaft provided on the movable chassis or the fixed chassis, the cam plate can be adjusted extremely easily so as to absorb dimension error of respective assemblies and error of attachment accuracy of assemblies. Therefore, it is possible to provide a cam mechanism of which adjustment work is easy.

Further, according to the magnetic recording and reproducing apparatus of the present invention, since the slide portion is formed at the position retreated one step by the protruded portion after the cam pin passed the eject side slide portion, the movable chassis can be moved earlier by the amount corresponding to the protruded amount of the protruded portion, thereby making it possible to rapidly move the movable chassis.

It should be understood by those skilled in the art that various modifications, combinations, sub-combinations and alterations may occur depending on design requirements and other factors insofar as they are within the scope of the appended claims or the equivalents thereof.

What is claimed is:

1. In a magnetic recording and reproducing apparatus comprising:
a fixed chassis to which a rotary head drum is attached;
a movable chassis slidably supported to said fixed chassis;
a cam gear rotatably supported to said fixed chassis or said movable chassis and which has a cam pin; and
a cam plate attached to said movable chassis or said fixed chassis and which has a guide groove with which said cam pin is slidably engaged, wherein said cam pin is moved along said guide groove as said cam gear is rotated, whereby rotation operation of said cam pin is transformed into slide operation of said movable chassis to make said movable chassis come close to or come away from said rotary head drum, a magnetic recording and reproducing apparatus characterized in that said guide groove includes an arc-like eject side slide portion which is dented in the opposite side of said rotary head drum, an arc-like play side slide portion which is dented in the side of said rotary head drum and a slide portion continued to one side of said eject side slide portion and said play side slide portion and which is extended in the direction substantially perpendicular to the direction in which said movable chassis is moved, positions of central points of radiuses of curvature of said eject side slide portion and said play side slide portion being displaced in the direction perpendicular to the direction in which said movable chassis is moved.

2. A magnetic recording and reproducing apparatus according to claim 1, wherein said cam plate is supported to said movable chassis or said fixed chassis such that it can be rotated about a supporting point shaft of said movable chassis or said fixed chassis.

3. A magnetic recording and reproducing apparatus according to claim 1, wherein said eject side slide portion and said play side slide portion of said slide portion have a protruded portion protruded toward the side of said play side slide portion.
